(19) United States
(12) Patent Application Publication
(10) Pub. No.: US 2015/0360731 A1
(43) Pub. Date: Dec. 17, 2015

(54) POWERED BOTTOM GUARD GROUP WITH ACTUATABLE ACCESS

(71) Applicant: Caterpillar Inc., Peoria, IL (US)

(72) Inventors: Prabhakar Gopalsamy, Chennai (IN); Robert A. Jackson, Edwards, IL (US); Christopher David Derham, East Peoria, IL (US); Morris Fee, Glasford, IL (US)

(21) Appl. No.: 14/301,362

(22) Filed: Jun. 11, 2014

(51) Int. Cl. B62D 25/24; B62D 55/084; E02F 9/24

(52) U.S. Cl. CPC B62D 25/24; E02F 9/24; B62D 55/0845

(57) ABSTRACT

The disclosure describes, in one aspect, a powered guard group for a machine, the guard group including a frame, a linkage, two doors, an actuator cylinder, and a cam disc mechanism with two actuator arms for moving the guard group between an open position and a closed position and the ways to access them.

### TECHNICAL FIELD

The present disclosure relates generally to a guard group for a machine and more particularly to a powered bottom guard group to protect and provide service access to the underside and/or mechanical components of the machine.

### BACKGROUND

Work machines, such as track-type tractors, utilize various types of guards to protect vulnerable portions of the machine. One particular type of guard is a bottom guard which is secured to the bottom of a work machine to protect portions of the engine, transmissions, or other vital machine components. This type of guard is generally assembled to the frame of the machine. In order to sufficiently protect the bottom and components of the work machine from impacts with objects such as rocks, stumps, soil and debris, the guards must have adequate structural integrity, high yield strength and adequate wear properties. The size and material requirements of the guards make the guard large and heavy, which make the guards difficult to remove during maintenance or repair event. In addition, work machines are often used in a range of conditions such as muddy conditions which can result in excessive debris accumulation on the guards and make it difficult to access the guards. The additional weight of the debris makes the guards even heavier.

One example of a bottom guard is illustrated in U.S. Pat. No. 4,957,180, titled Guard Assembly for a Vehicle. The '180 Patent discloses a guard assembly for protecting the lower portions of an earthmoving machine which protect critical components and systems, such as the engine, transmission and drive train. The guard assembly includes a guard plate fastened to the machine frame using threaded fasteners.

The foregoing background discussion is intended solely to aid the reader. It is not intended to limit the disclosure, and thus should not be taken to indicate that any particular element of a prior system is unsuitable for use within the disclosure, nor is it intended to indicate that any element, including solving the motivating problem, is essential in implementing the systems and methods described herein. The implementations and application of the systems and methods described herein are defined by the appended claims.

### SUMMARY OF THE INVENTION

The disclosure describes, in one aspect, a guard group assembled to the frame of a work machine including a door having an inner side, an outer side, a first edge and a second edge, the first edge being opposite of the second edge, the door being configured to move between a closed position and an open through two actuator aims moving around a cam disc coupled with the actuator. In addition, the guard group includes a frame coupled to the linkage, the frame having at least two stiffeners, the stiffeners being configured to contact the inner side and inhibit the door from moving when the door is in the closed position and is contacted by a rock, stump or the like; and an actuator linked with actuator arm and cam disc, the actuator cylinder piston extends or retracts which rotates the cam disc and in turn pushes or pulls the two actuator arms to move the doors between the open and closed positions.

In another aspect, the disclosure describes a guard group for a machine including a first door movable between a closed position and an open position, the first door being configured to inhibit rocks, branches and the like from striking a mechanical component when the first door is in the closed position and a second door movable between a closed position and an open position, the second door being configured to inhibit rocks, branches and the like from striking a mechanical component when the second door is in the closed position. The guard group also includes two actuator arms and cam disc coupled to the first door, a similar set of two actuator arms and cam disc coupled to the second door, a first actuator coupled to the first linkage, the first power actuator being configured to move the first door between the closed position and the open position through the actuator arm and cam arrangement; and a second actuator coupled to the second linkage, the second power actuator being configured to move the second door between the closed position and the open position through the actuator arm and cam arrangement.

In yet another aspect the disclosure describes a machine having a chassis, a work implement coupled to the chassis, a prime mover coupled to the chassis, a first and second track assembly powered by the prime mover and configured to selectively move the machine; and a guard group coupled to the chassis. The guard group includes a first guard mounting surface coupled to the chassis, a second guard mounting surface, a first stiffener and a second stiffener coupled to the first guard mounting surface and the second guard mounting surface, a linkage coupled to the first guard mounting surface, a door coupled to the linkage, the door being configured to move between a closed position and an open position and an actuator coupled to the linkage, the actuator being configured to move the door between the closed position and the open position.

### BRIEF DESCRIPTION OF THE DRAWINGS

FIG. 1 is a side view of a machine which may incorporate a bottom guard group assembly according to the present disclosure.

FIG. 2 is a perspective view of a housing and chassis for a machine shown in FIG. 1, showing first and second guard groups of a guard assembly according to the present disclosure with cam discs, actuator arms and doors in an open position.

FIG. 3 is an end view of the guard assembly of FIG. 2 with the doors of first and second guard groups in an open position.

FIG. 4 is a perspective view of the guard assembly of FIG. 2 showing the first and second guard groups in a closed position.

FIG. 5 is a perspective view of the guard assembly of FIG. 2 showing the first and second guard groups in an open position.

FIG. 6 is an end view of the housing and chassis of FIG. 2, showing the first guard group in a closed position; and

FIG. 7 is an end view of the housing and chassis of FIG. 2, showing the first guard group in an open position.

FIG. 8 is a side view of the guard group with the doors showing the position of the stopper when the doors are in closed position.

FIG. 9 is a side view of the guard group with the doors showing the position of the stopper when the doors are in open position.

FIG. 10 is a bottom view of the bottom portion of the guard group which shows the doors of the guard assembly in closed and bolted position.

FIG. 11 is a side view of the guard group with the guard assembly suspended on a hinge attached to the frame.

### DETAILED DESCRIPTION

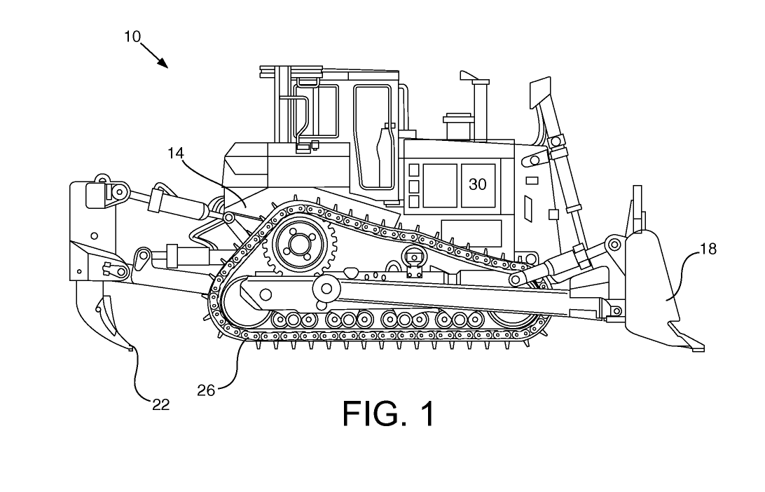

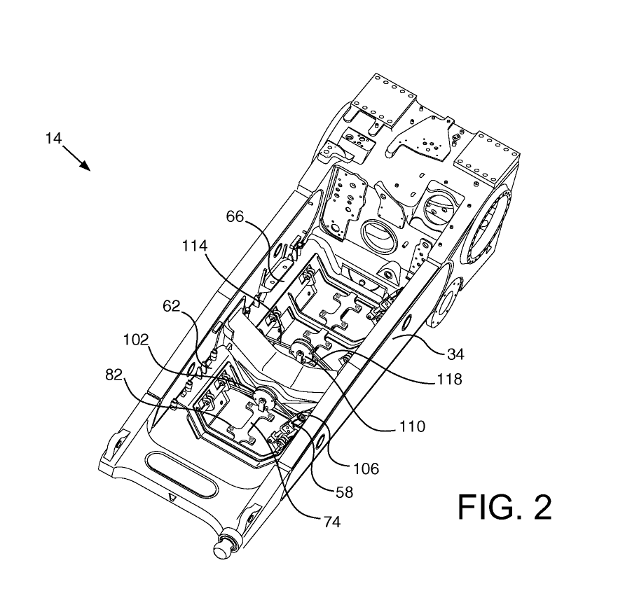

Referring now to FIG. 1, a machine 10 is a track-type tractor, however the present disclosure guard assembly is not limited to track-type tractors and is applicable to other machines such as off highway trucks, skid steer machines, backhoe loaders, landfill compactors, shovels, excavators, motor graders, wheel loaders and the like. The machine 10 includes a chassis 14, a first work implement 18, a second work implement 22, a prime mover 30, two track assemblies 26 and a guard assembly 38 (FIG. 2). The work implement 18 may be a blade and the second work implement 22 may be a ripper coupled to the chassis 14 as is customary. The prime mover 30 may be an internal combustion engine which is supported by the chassis 14 (FIG. 2). The two track assemblies 26 (the left track not shown) are powered by the prime mover 30 and a transmission (not shown) is connected to the prime mover 30 to allow the operator to selectively move the machine 10. As best seen in FIG. 2, the guard assembly 42 allows service personnel to access the prime mover 30, torque converter (not shown), driveshaft (not shown) and is coupled to the chassis 14 as is described in further detail below.

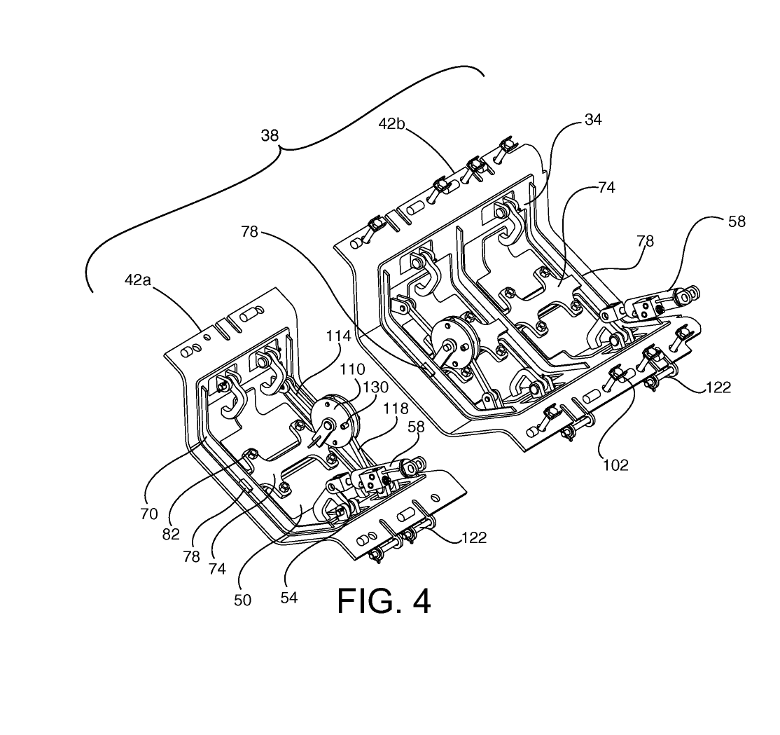

The guard group 38 will now be described. As best shown in FIGS. 2 and 4, the guard group 38 is attached to an underside of the machine 10 (FIG. 1) and is positioned approximately in a center portion of the underside of the machine 10. The guard group 38 includes two actuatable guard assemblies, namely, front guard assembly 42a and rear guard assembly 42b. Since guard assemblies 42a and 42b are substantially similar—except rear guard assembly 42b covers a larger opening—the front guard assembly 42a will first be described and any difference in the rear guard assembly 42b will be noted. The front guard assembly 42a includes a frame 34a, two doors 50a, four linkages 54, an actuator cylinder 58, first actuator arm 114, second actuator arm 118 and a cam disc 110.

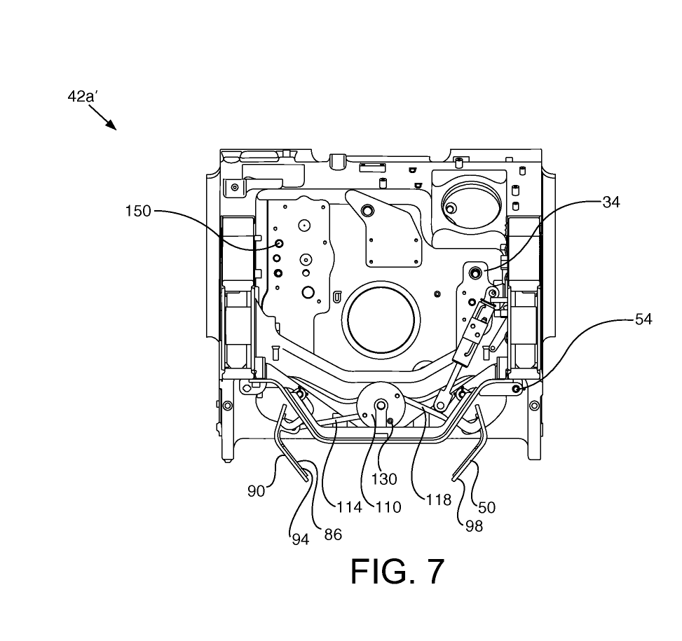

The frame 34a, as best shown in FIG. 4, includes a guard mounting portion 62a, a plurality of stiffeners 70 and a cross-member 74a. The guard mounting portion 62a is sized and configured to allow the frame 34a to be attached to the chassis 14 of the machine 10 (FIG. 1). The guard mounting portion 62a may be coupled to the chassis 14 by welding, fasteners or the like. As best seen in FIG. 7, the guard mounting portion 62a and the chassis 14 are bolted together with bolts 102 (FIG. 4). The first guard mounting portion 62a is contoured to match the contour of the chassis 14. The plurality of stiffeners 70 extend along the U-shaped contour of the front frame 34a to help provide support to the front frame 34a. Regarding the general construct of the rear frame 34b, three stiffeners 70 extend along the U-shaped portion of this frame 34b to stiffen the frame and provide a solid foundation for the door 50b, actuator 58 and linkage 114, 118 assemblies. Each cross-member 74b of the rear guard assembly 42b, longitudinally extends along the centerline of the guard assembly 42b and interacts with the three stiffeners 70 to provide a solid under-belly structure to rigidly support and protect doors 50b. As can be seen in FIG. 4, the cross-members 74b are disposed approximately in the center of the guard assembly 42band are rigidly attached at ends thereof to the plurality of stiffeners 70 at center-end portions 78b of each of the plurality of stiffeners 70. The cross-members 74b includes threaded openings 82 to receive the door bolts 134 which allow the doors 50b to be secured to the cross-members 74 via the fasteners coinciding with a locked condition of doors—typically locked during machine operation, for example. Similarly, the front guard assembly 42a has a similar construct relative to the rear guard assembly 42b, however due to the shorter span only one cross-member 74a is required.

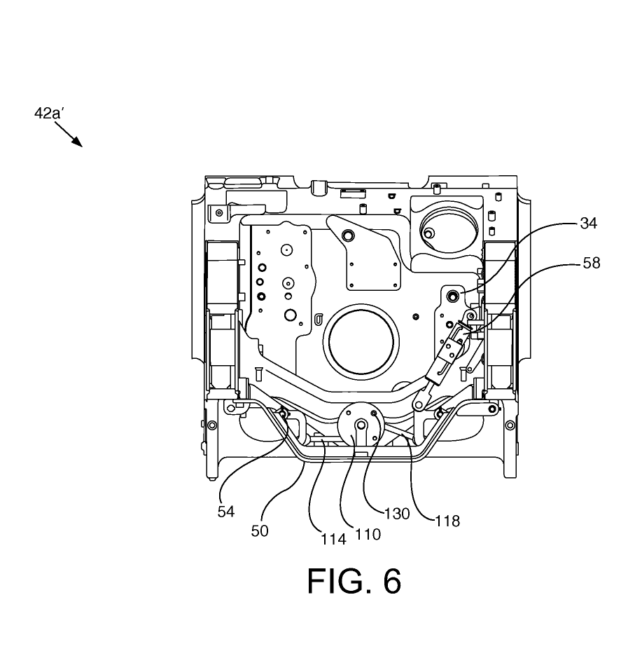

The front guard assembly 42a includes two doors 50a, although it is contemplated that a single door may also be used. Each door 50a includes an inner side 86a, an outer side 90a, a first edge 94a and a second edge 98a. The first edge 94a is disposed opposite of the second edge 98a. The door 50a is configured to pivot between a closed position (FIG. 6) and an open position (FIG. 7). In the illustrated embodiment the door 50a is contoured in an L-shaped configuration to match the contour of the frame 34a. Each door 50a also includes threaded openings 82 which allow the door bolts 134 to pass through and engage with the four threaded openings 82 within the cross-member 74a. In this manner, the doors 50a may be left closed in the machine operational state and then actuated to the open position in preparation for a service event.

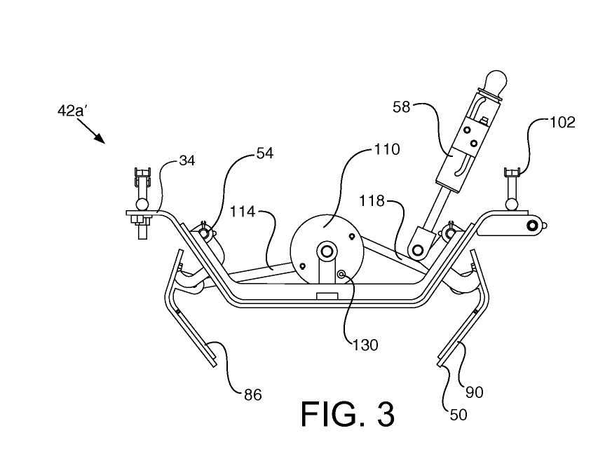

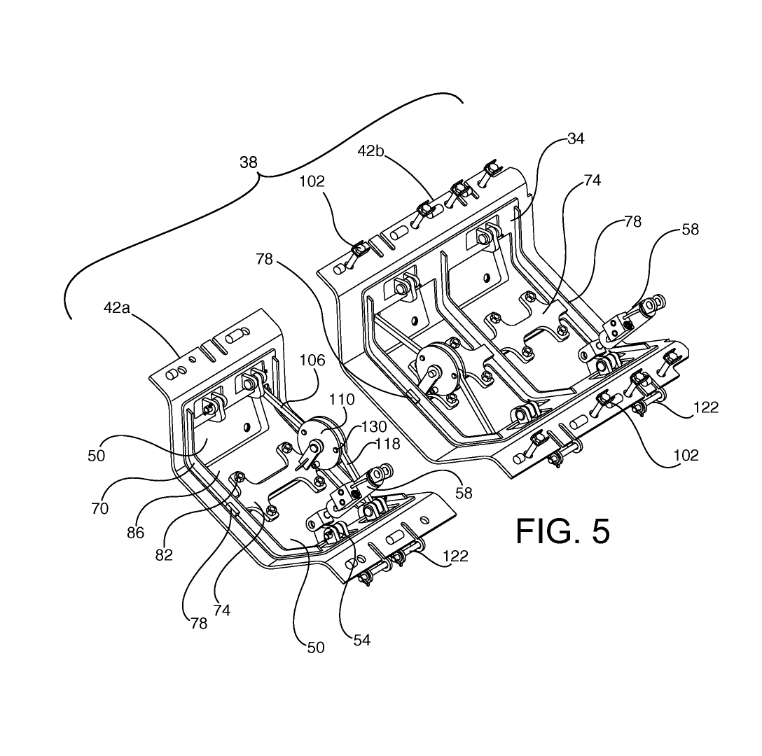

Referring to FIGS. 4 and 5, the linkage assembly 54 will now be described. The guard assemblies 42a, 42b each include four linkages 54. Each linkage 54 is substantially similar, so only the linkage 54 relative to the front guard assembly 42a will be described. The linkage 54 is attached to the door 50a on a first end and is pivotally attached to the frame 34a to allow the linkage 54 to rotate with respect to the frame 34a. The linkage 54 is approximately in the shape of a “C”, and in an exemplary embodiment, two linkages 54 are attached to each door 50a. As is best seen in FIG. 5, each linkage 54 serves to support the door 50a when the front guard assembly 42a is in the open position. The linkage 54 also supports each door 50a when the front guard assembly 38 is in the open position (FIG. 3).

Referring to FIG. 3, the actuator cylinder 58 will now be described. The actuator cylinder has a rod end which is attached to the linkage 54 and, in turn, the linkage 54 is attached to the door 50a. The first actuator arm 114 has a first end attached to the door 50a and a second end which is attached to a cam disc 110 and as the rod of the actuator cylinder 58 is moved the door 50a and first actuator arm 114 is moved. As the cam disc 110 is urged to rotate by the actuator arm 114 the second actuator arm 118 is urged to rotate. The other end of the second actuator arm is attached to the other door 50a and therefore the door is urged to move through the second actuator arm 118 based on movement of the cam disc 110. In an exemplary embodiment the actuator cylinder 58 has its rod end attached by a pin and u-clip join on the door 50a and its cylinder end is attached to the frame 34 which is secured to the chassis 14. The actuator cylinder 58 serves to move one of the doors 50a which in turn moves the other door contemporaneously via the cam disc 110 and linkage arms 114, 118. The actuator cylinder 58 is structured and arranged to position each of the front and rear guard assemblies 42a, 42b of the guard group 38 to change the door 50a, 50b posture from the open position to the closed position. In an exemplary embodiment the actuator cylinder 58 are hydraulic actuators, however it is envisioned that other actuators, such as electric motors, for example may be used however increase expense and complication. The actuator cylinder 58 extends and retracts to open a first door 50a, 50b which, in turn, urges rotation of the cam discs 110 which in turn moves the first and second actuator arms 114, 118 which urges the remaining doors 50a, 50b to open/close harmoniously with the door connected to the actuator.

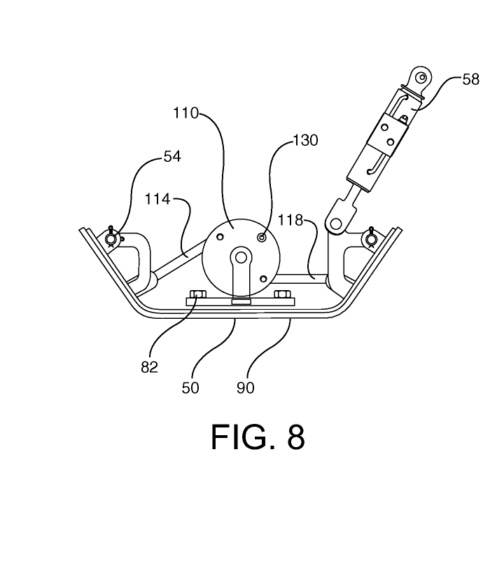

Referring to FIG. 8 the actuator cylinder 58 will be described. The actuator cylinder 58 rod end is withdrawn inside which is attached to the first actuator arm 114 and second actuator arm 118 which allows the door 50 to be under closed position. During this condition the stopper 130 is seen on top of the disc. And the first actuator arm 114 and second actuator arm 118 can be seen in retracted position.

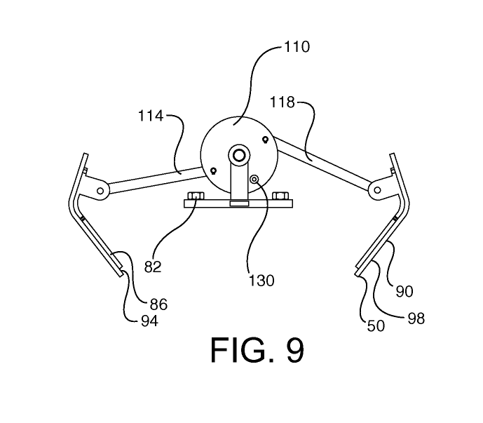

Referring to FIG. 9 the actuator arms 114 and 118 will be described. The first actuator arms 114 and the second actuator 118 extend's which in order allows the guard group to open the doors 50 from the closed position to open position. During this condition the stopper 130 is seen at the bottom of the disc which prevents the excess movement of the cam disc 110.

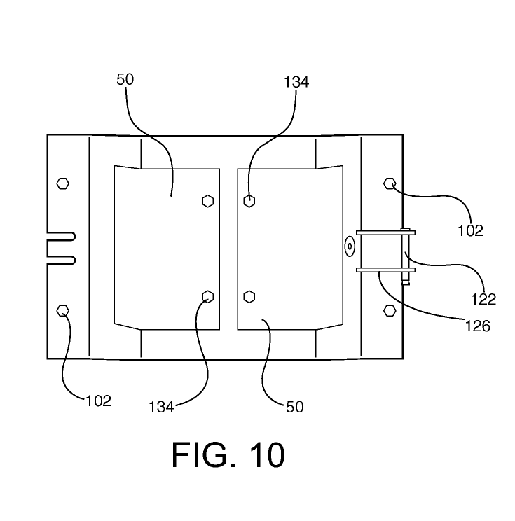

Referring to FIG. 10 the access to the guard group 38 will be described. The bottom guard has four major bolts 102, on the frame 34, which can be removed to access the entire guard group 38 for major service.

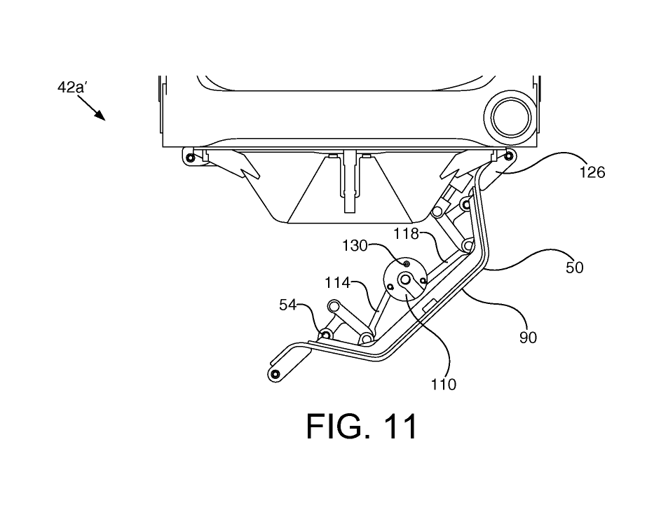

Referring to FIG. 11 the opening of the entire guard group 38 is described. The guard group 38 is attached to the hinge 122 in the frame 34. Removing the bolts 102 (FIG. 10) will allow the guard group to suspend from the hinge 122 which is an integral part of the frame 34.

### INDUSTRIAL APPLICABILITY

The guard group 38 is useful for protecting an underside of a machine 10 and more specifically mechanical components, such as the prime mover 30, a transmission, a hydraulic pump, etc., of the machine 10 from striking stumps, rocks or the like when the machine 10 is moving. The guard group 38 is also useful for protecting the mechanical components from debris accumulation, tar, oil sands or the like. Machines 10 need maintenance or repairs and the guard group 38 is useful for allowing maintenance personnel easy access to the mechanical components protected by the guard group 38. The guard group 38 is preferred over other guards because the guard group 38 is powered, thus the maintenance personnel are not required to remove a large, heavy guard group from the machine rather, the guard group 38 may be powered between the open position and the closed position.

If the guard group 38 is in the open position and maintenance personnel wish to move it to the closed position, the maintenance personnel powers the actuator cylinder 58 to move the first actuator arm 114 and the second actuator arm 118 through the cam disc 110, and thus changes the guard group 38, into closed position. In the illustrated embodiment the actuator cylinder 58 is powered by a hydraulic pump that is separate from the machine 10, while in other embodiments the actuator cylinder 58 may receive power from the hydraulic pump on the machine 10. The actuator cylinder 58 is sufficiently strong to hold the guard group 38 in the closed position, but maintenance personnel may wish to couple the doors 50 to the frame 34 with door bolts 134 or the like to minimize the possibility of the doors 50 from moving when struck by stumps, rocks or the like.

If the guard group 38 is in the closed position and maintenance personnel wish to move it to the open position, the maintenance personnel must first remove the door bolts 134 coupling the doors 50 to the frame 34. The maintenance personnel then power the actuator cylinder 58 to move the actuator cylinder 58, and thus the guard group 38, into the open position. When the guard group 38 is in the open position mechanical components are accessible for maintenance or repairs.

The guard group 38 may be removed from the machine 10, if a large mechanical component, such as the oil pan, needs to be removed from the machine 10.

The guard group 38 can be accessed for minor service by removing the four door bolts 134 which are fastened to the threaded opening 82 welded to the cross members 74.

The guard group 38 can be accessed for major service by removing the bolts 102 which are attached to the frame 34. Removing the four bolts 102 will allow the guard group 38 to suspend from the hinge 122 and to move between open and close positions upon actuation of actuator cylinder 58, during which the door bolts 134 should not be removed.

It will be appreciated that the foregoing description provides examples of the disclosed system and technique. However, it is contemplated that other implementations of the disclosure may differ in detail from the foregoing examples. All references to the disclosure or examples thereof are intended to reference the particular example being discussed at that point and are not intended to imply any limitation as to the scope of the disclosure more generally. All language of distinction and disparagement with respect to certain features is intended to indicate a lack of preference for those features, but not to exclude such from the scope of the disclosure entirely unless otherwise indicated.

Accordingly, this disclosure includes all modifications and equivalents of the subject matter recited in the claims appended hereto as permitted by applicable law. Moreover, any combination of the above-described elements in all possible variations thereof is encompassed by the disclosure unless otherwise indicated herein or otherwise clearly contradicted by context.

What is claimed is:

1. A guard group for a work machine comprising:
a door having an inner side, an outer side, a first edge and a second edge, the first edge being opposite of the second edge, the door being configured to move between a closed position and an open position;
a linkage coupled to the door;
a frame coupled to the linkage, the frame having at least two stiffeners, the stiffeners being configured to contact the inner side and inhibit the door from moving when the door is in the closed position and is contacted by a rock, stump or the like; and
an actuator coupled to the linkage, the actuator being configured to move the door between the closed position and the open position.
a cam disc mechanism coupled to the first actuator arm and second actuator arm and thereafter to the door, which makes the mechanism to work on single actuator.

2. The guard group of claim 1 further comprising a cross-member coupled to at least one of the at least two stiffeners, the cross-member being coupled to the at least one of the at least two stiffeners at a center portion of the at least one of the at least two stiffeners.

3. The guard group of claim 1 wherein the frame comprises at least three stiffeners, each stiffener being configured to contact the inner side and inhibit the door from moving when the outside side is contacted by a rock, stump or the like.

4. The guard group of claim 3 wherein the linkage is pivotally coupled to the frame.

5. The guard group of claim 4 wherein the actuator is a hydraulic actuator.

6. The guard group of claim 1 wherein the second edge is configured to be selectively coupled to the frame using a fastener when the door is in the closed position.

7. The guard group of claim 1 wherein the actuator is coupled to the frame.

8. A guard group for a machine comprising:
a first door movable between a closed position and an open position, the first door being configured to inhibit rocks, branches and the like from striking a mechanical component when the first door is in the closed position;
a second door movable between a closed position and an open position, the second door being configured to inhibit rocks, branches and the like from striking a mechanical component when the second door is in the closed position;
a first linkage coupled to the first door;
a second linkage coupled to the second door;
a first actuator coupled to the first linkage, the first power actuator being configured to move the first door between the closed position and the open position.
a second actuator coupled to the second linkage, the second power actuator being configured to move the second door between the closed position and the open position and
a guard group is completely hinged to the frame, which can be accessed by removal of the bolts.

9. The guard group of claim 8 further comprising a frame having a first guard mounting surface, a second guard mounting surface, a first stiffener, a second stiffener and a third stiffener wherein the first stiffener, second stiffener, and third stiffener are each coupled to the first guard mounting surface and the second guard mounting surface and further wherein the first linkage is coupled to the first guard mounting surface and the second linkage is coupled to the second guard mounting surface.

10. The guard group of claim 9 further comprising a third linkage and a fourth linkage, the third linkage being coupled to the first door and the fourth linkage being coupled to the second door.

11. The guard group of claim 9 further comprising a cross-member coupled to at least one of the first stiffener, second stiffener and third stiffener and wherein the first door is configured to be selectively coupled to at least one of the cross-member, first stiffener, second stiffener and third stiffener using a fastener when the first door is in the closed position.

12. The guard group of claim 9 wherein the actuator is hydraulically powered.

13. A machine comprising:
a chassis;
a work implement coupled to the chassis;
a prime mover coupled to the chassis;
a first and second track assembly powered by the prime mover and configured to selectively move the machine; and
a guard group coupled to the chassis, the guard group comprising:
a first guard mounting surface coupled to the chassis;
a second guard mounting surface;
a first stiffener and a second stiffener coupled to the first guard mounting surface and the second guard mounting surface;
a linkage coupled to the first guard mounting surface;
a door coupled to the linkage, the door being configured to move between a closed position and an open position;
an actuator coupled to the linkage, the actuator being configured to move the door between the closed position and the open position.
a first actuator arm coupled to cam disc and the first door linkage;
a second actuator arm coupled to cam disc and second door linkage;
a second door coupled to the linkage, the second door being configured to move between a closed position and an open position simultaneously.

14. The machine of claim 13 further comprising a second door and a second linkage, the second linkage being coupled to the second guard mounting surface and the second door, the second door being configured to move between a closed position and an open position.

15. The machine of claim 13 wherein the door is configured to inhibit rocks, branches and the like from striking a mechanical component when the door is in the closed position.

16. The machine of claim 15 further comprising a third linkage coupled to the door and the first guard mounting surface.

17. The machine of claim 15 wherein the actuator is a hydraulic actuator.

18. The machine of claim 17 wherein the work machine is a track-type tractor.

19. The machine of claim 13 further comprising a cross-member coupled to the first stiffener, the cross-member being perpendicular to the first stiffener and wherein the door is selectively coupled to the cross-member when the door is in the closed position.

20. The machine of claim 19 wherein the cross-member inhibits the door from moving when a rock, stump or the like presses against the door.
